(19) United States
(12) Patent Application Publication
(10) Pub. No.: US 2026/0298474 A1
(43) Pub. Date: Oct. 1, 2026

(54) COOKING APPLIANCE AND KNOB ASSEMBLY THEREOF

(71) Applicant: Haier US Appliance Solutions, Inc., Wilmington, DE (US)

(72) Inventor: Paul Bryan Cadima, Crestwood, KY (US)

(21) Appl. No.: 19/091,997

(22) Filed: Mar. 27, 2025

(51) Int. Cl. F24C 3/12; F24C 7/08; G05G 1/08; G05G 5/00; G05G 5/05

(52) U.S. Cl. CPC F24C 3/126; F24C 7/082; G05G 1/082; G05G 5/005; G05G 5/05; G05G 2505/00

(57) ABSTRACT

A cooking appliance may include a control knob mounted to the cooking appliance at a surface panel. The control knob may include an adjustable body that may include a push body, a center projection that may define a body opening, and a center cylinder positioned radially inward of the push body. The control knob may include a static body disposed within the body opening of the center projection. The control knob may include a first spring and a second spring each disposed around the center cylinder. The second spring and the first spring may be in a series arrangement. The control knob may include a support plate selectively rotatable between a first discrete preload position and a second discrete preload position relative to the static body to selectively adjust the control knob between a first discrete preload setting and a second discrete preload setting.

### FIELD OF THE DISCLOSURE

The present subject matter relates generally to a cooking appliance, and more particularly to a knob assembly for a cooking appliance.

### BACKGROUND OF THE DISCLOSURE

Knobs are commonly used on a variety of commercial and residential appliances to control an operating condition of the appliance. Knobs are particularly common on cooking appliances, such as stoves or cooktops. Various shapes and sizes can be used depending upon, for example, the intended application, aesthetics, and other factors.

For example, cooking appliances that include a cooktop traditionally have at least one heating element positioned on a panel proximate a cooktop surface for use in heating or cooking an object, such as a cooking utensil, and its contents. The heating element can operate to heat a cooking utensil directly through induction heating or can use another heat source such as electrically resistant coils or gas burners. Commonly, one knob corresponds to one or more heating elements such that rotation of the knob activates, ignites, or otherwise adjusts heat generated at the corresponding heating elements. In order to prevent accidental or inadvertent activation of the corresponding heating elements, many knobs require a compound movement (e.g., a push, a pinch, a squeeze, or the like in combination with a rotation of the knob) to activate or ignite the heating elements from rest (e.g., a state in which no heat is being generated at the heating elements or no fuel is being flowed to the same). For example, a valve or switch box to which the knob is connected can require the knob to be pushed inward before the knob can be rotated (e.g., to adjust the volume of fuel flowed to the heating element or otherwise alter the heat generated at the heating elements).

Certain drawbacks exist with these existing constructions, however. For example, such constructions often require pinching or squeezing efforts from a user before the knob can be rotated. Users having physical limitations, such as decreased hand dexterity, can have difficulties performing these efforts. As another example, existing constructions can still be susceptible to accidental activation that can occur, for instance, when a user leans on the knob and subsequently moves such that the knob is rotated.

Accordingly, a knob assembly that obviates one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a cooking appliance is provided. The cooking appliance may include a cooktop. The cooking appliance may include a heating element mounted to the cooktop. The cooking appliance may include a surface panel mounted to the cooktop forward from the heating element. The surface panel may include a forward face and a rearward face. The surface panel may define a central axis extending from the rearward face to the forward face. The cooking appliance may include a control knob mounted to the cooking appliance at the surface panel. The control knob may include an adjustable body that may include a push body, a center projection defining a body opening, and a center cylinder positioned radially inward of the push body. The control knob may include a static body disposed within the body opening of the center projection. At least a portion of the static body may be positioned in front of the center cylinder. The control knob may include a first spring disposed around the center cylinder. The control knob may include a second spring disposed around the center cylinder. The second spring and the first spring may be in a series arrangement. The control knob may include a support plate selectively rotatable between a first discrete preload position and a second discrete preload position relative to the static body to selectively adjust the control knob between a first discrete preload setting and a second discrete preload setting.

In another exemplary aspect of the present disclosure, a knob assembly for a cooking appliance is provided. The cooking appliance may include a cooktop, a heating element mounted to the cooktop, and a surface panel mounted to the cooktop forward from the heating element. The surface panel may include a forward face and a rearward face. The surface panel may define a central axis extending from the rearward face to the forward face. The knob assembly may include a control knob mountable to the cooking appliance. The control knob may include an adjustable body that may include a push body, a center projection defining a body opening, and a center cylinder positioned radially inward of the push body. The control knob may include a static body disposed within the body opening of the center projection. At least a portion of the static body being positioned in front of the center cylinder. The control knob may include a first spring disposed around the center cylinder. The control knob may include a second spring disposed around the center cylinder. The second spring and the first spring may be in a series arrangement. The control knob may include a support plate selectively rotatable between a first discrete preload position and a second discrete preload position relative to the static body to selectively adjust the control knob between a first discrete preload setting and a second discrete setting preload.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to one or more exemplary embodiments of the present disclosure.

FIG. 2 provides a cross-sectional view of a knob assembly of the exemplary cooking appliance of FIG. 1.

FIG. 3 provides an exploded perspective view of a control knob of the exemplary cooking appliance of FIG. 1.

FIG. 4 provides an exploded perspective view of a control knob of the exemplary cooking appliance of FIG. 1.

FIG. 5 provides a rear perspective view of a control knob of the exemplary cooking appliance of FIG. 1, wherein a support plate of the control knob is in a first discrete preload position.

FIG. 6 provides a rear perspective view of a control knob of the exemplary cooking appliance of FIG. 1, wherein a support plate of the control knob is in a second discrete preload position.

FIG. 7 provides a sectional perspective view of a control knob of the exemplary cooking appliance of FIG. 1 in a static state, wherein a support plate of the control knob is in a first discrete preload position.

FIG. 8 provides a sectional perspective view of a control knob of the exemplary cooking appliance of FIG. 1 in an adjustable state, wherein a support plate of the control knob is in a first discrete preload position.

FIG. 9 provides a sectional perspective view of a control knob of the exemplary cooking appliance of FIG. 1 in a static state, wherein a support plate of the control knob is in a second discrete preload position.

FIG. 10 provides a sectional perspective view of a control knob of the exemplary cooking appliance of FIG. 1 in an adjustable state, wherein a support plate of the control knob is in a second discrete preload position.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

As used herein, the term “spring rate” may refer to an amount of force required to compress or extend a spring by a unit of distance.

Many existing knob assembly for cooking appliances require a complex movement to be activated. For example, many existing knob assemblies require a control knob to be depressed prior to rotation, for instance, to activate a heating element. In many instances, the push to turn functionality relies on components, such as a valve switch, positioned within an interior of the cooking appliance. However, many drawbacks exist with such knob assemblies. In particular, such knob assemblies require a discrete push force to depress the control knob. Such knob assemblies can be accidently or unintentionally engaged, for instance, when a user leans on the control knob and subsequently moves such that the control knob of the knob assembly is rotated.

Embodiments of the present disclosure provide a knob assembly configured for adjusting a push force required to depress the knob assembly. For example, embodiments of the present disclosure provide a knob assembly that includes an adjustable preload setting for adjusting a push force that is required to depress the control knob. In particular, embodiments of the present disclosure provide a support plate for the control knob that advantageously selectively rotatable (e.g., between a first discrete preload position and a second discrete preload position) to selectively adjust a preload setting of the control knob. The preload setting may correspond to a push force required to depress the control knob. Thus, the support plate can advantageously selectively increase a push force required to depress the control knob, thus decreasing or mitigating chances of accidental or unintentional depression of the control knob.

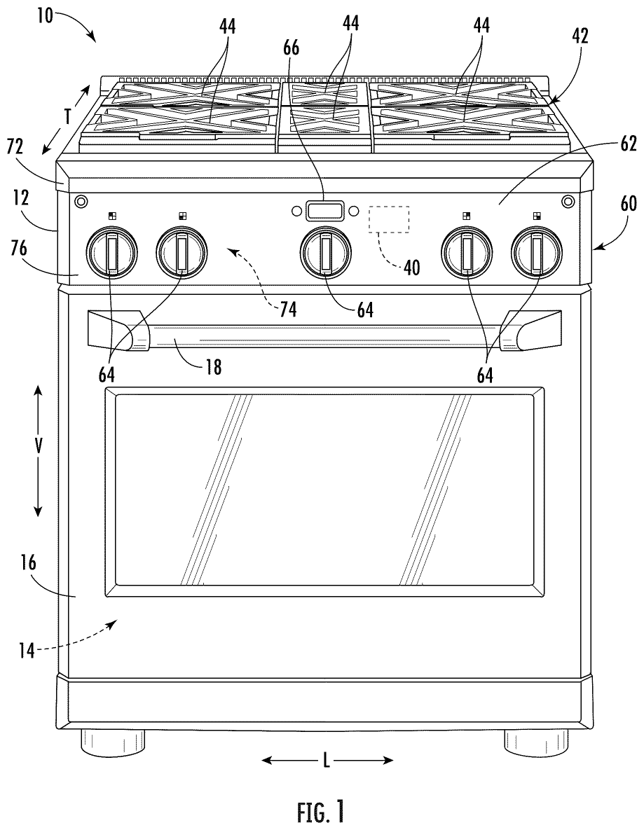

Turning now to the figures, FIG. 1 provides a perspective view of a cooking appliance, such as an oven appliance 10, according to exemplary embodiments of the present disclosure. Generally, oven appliance 10 defines a vertical direction V, a lateral direction L, and a transverse direction T. The vertical direction V, lateral direction L, and transverse direction T are mutually perpendicular and form an orthogonal direction system. As will be understood, oven appliance 10 is provided by way of example only, and the present subject matter may be used in any suitable appliance. Thus, the present disclosure may be used with other oven, range, or cooktop appliance configurations (e.g., configurations that define multiple interior cavities for the receipt of food, include no interior cavities, or are otherwise different than the configuration shown in FIG. 1), as well as other suitable appliances, as would be understood in light of the present disclosure.

Oven appliance 10 includes an insulated cabinet 12 with an interior cooking chamber 14 defined by an interior surface of cabinet 12. Cooking chamber 14 is configured for the receipt of one or more food items to be cooked. Oven appliance 10 includes a door 16 rotatably mounted to cabinet 12 (e.g., with a hinge—not shown). A handle 18 may be mounted to door 16 and may assist a user with opening and closing door 16 in order to access an opening to cooking chamber 14. For example, a user can pull on handle 18 to open or close door 16 and access cooking chamber 14 through the opening. As would be understood, one or more internal heating elements (e.g., baking or broiling heating elements) may be provided within cooking chamber 14 to cook or otherwise heat items therein.

Oven appliance 10 may include a seal between door 16 and cabinet 12 that assist with maintaining heat and cooking fumes within cooking chamber 14 when door 16 is closed, as shown in FIG. 1. One or more parallel glass panes 22 provide for viewing the contents of cooking chamber 14 when door 16 is closed and assist with insulating cooking chamber 14. Optionally, a baking rack may be positioned in cooking chamber 14 for the receipt of food items or utensils containing food items.

In some embodiments, oven appliance 10 includes a cooktop surface 42 having one or more heating elements 44 for use in heating or cooking operations. In exemplary embodiments, cooktop surface 42 includes a metal (e.g., steel) panel on which one or more grates may be supported. In other embodiments, however, cooktop surface 42 includes another suitable material, such as a ceramic glass or another suitable non-metallic material. Heating elements 44 may be various sizes, as shown in FIG. 1, and may employ any suitable method for heating or cooking an object, such as a cooking utensil (e.g., a pot, pan, or the like), and its contents. In one embodiment, for example, heating element uses a heat transfer method, such as electric coils or gas burners, to heat the cooking utensil. In another embodiment, however, heating element 44 uses an induction heating method to heat the cooking utensil directly. In turn, heating element may include a burner element, electric heat element, induction element, or another suitable heating element.

Some embodiments of oven appliance 10 include a controller 40 (e.g., configured to control one or more operations of oven appliance 10). For example, controller 40 may control at least one operation of oven appliance 10 that includes an internal heating element or cooktop heating element 44. Controller 40 may be in communication (via for example a suitable wired or wireless connection) with one or more of heating element(s) 44 and other suitable components of oven appliance 10, as discussed herein. In general, controller 40 may be operable to configure oven appliance 10 (and various components thereof) for cooking. Such configuration may be based, for instance, on a plurality of cooking factors of a selected operating cycle or mode.

By way of example, controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 40 may be positioned in a variety of locations throughout oven appliance 10. As illustrated, controller 40 may be located within a user interface 62 of oven appliance 10. In some such embodiments, input/output (“I/O”) signals may be routed between controller 40 and various operational components of oven appliance 10, such as heating element(s) 44, control knobs 64, display component 66, sensors, alarms, or other components as may be provided. For instance, signals may be directed along one or more wiring harnesses that may be routed through cabinet 12. In some embodiments, controller 40 is in communication with user interface assembly 62 and control knobs 64 through which a user may select various operational features and modes and monitor progress of oven appliance 10. In one embodiment, user interface assembly 62 may represent a general purpose I/O (“GPIO”) device or functional block. In one embodiment, user interface assembly 62 may include input components, such as one or more of a variety of electrical, mechanical, or electro-mechanical input devices including rotary dials, push buttons, and touch pads. User interface assembly 62 may include a display component 66, such as a digital or analog display configured to provide operational feedback to a user.

During use of oven appliance 10, the amount of heat delivered by each heating element 44 on cooktop 42 may be controlled by controller 40 and a corresponding knob assembly 60, described in detail below. For instance, knob assembly 60 may include one or more control knobs 64 mounted (e.g., rotatably) on a surface panel 76 of user interface 62 forward from heating elements 44 (e.g., along or relative to the transverse direction T). Each control knob 64 may correspond to a discrete heating element 44.

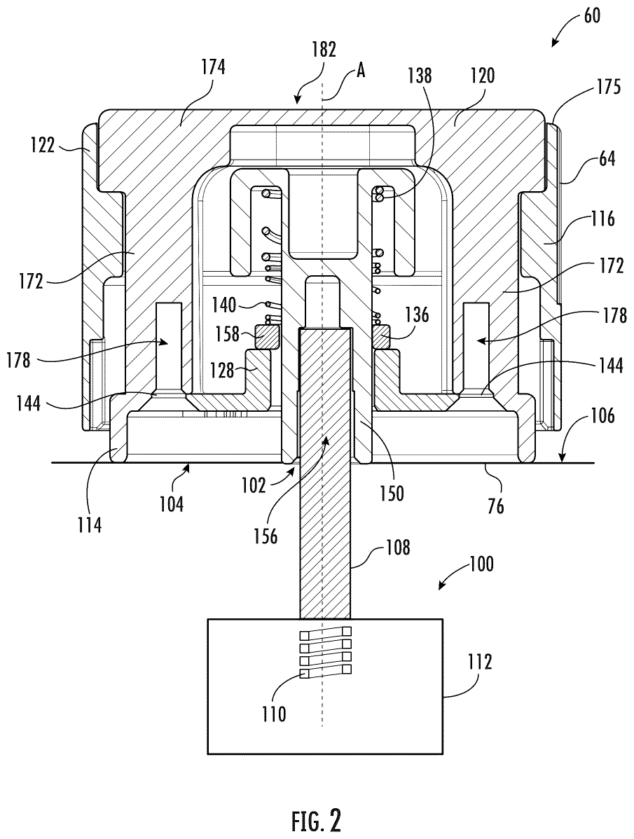

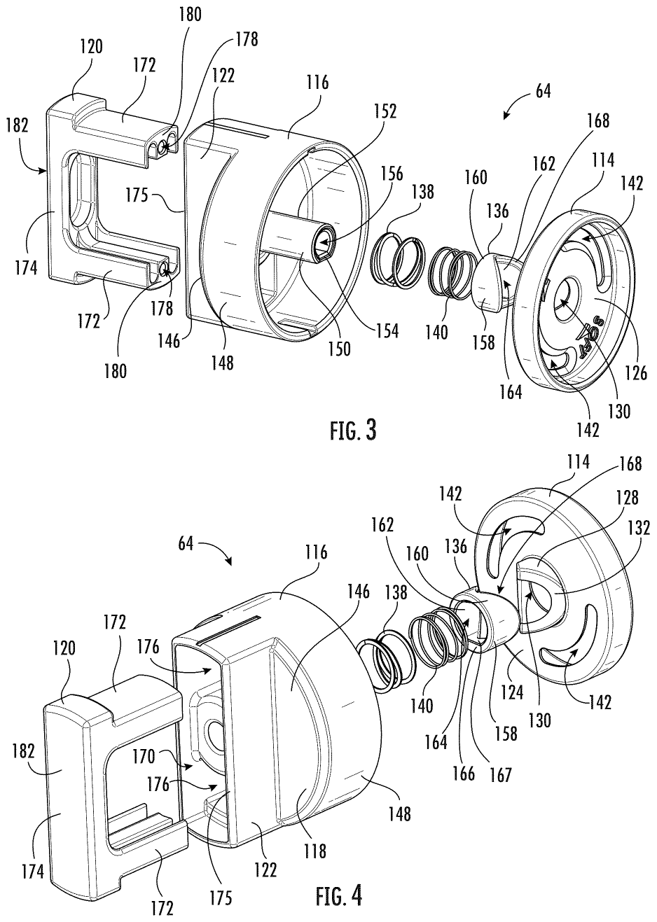

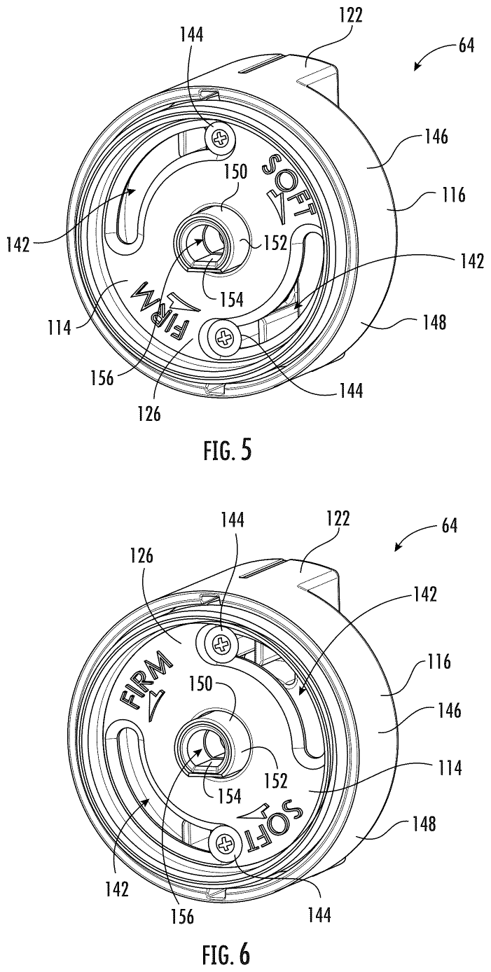

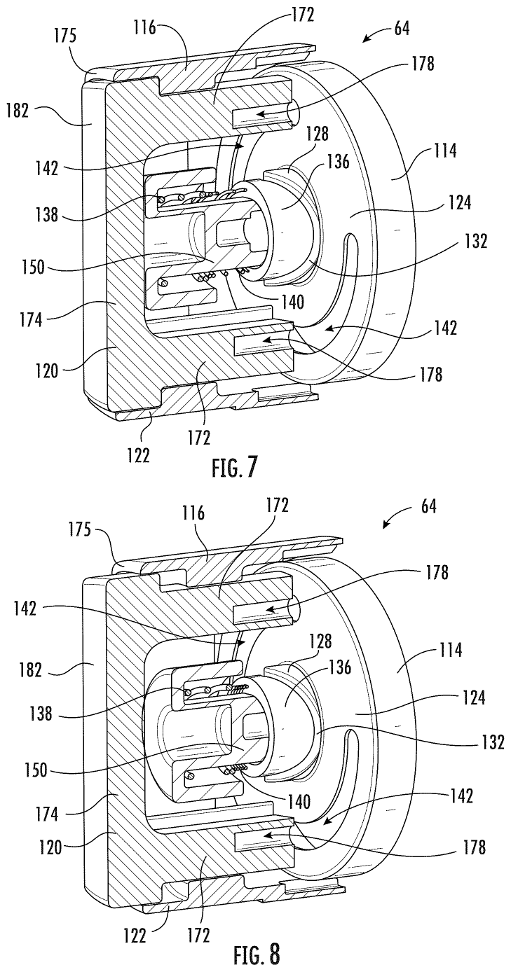

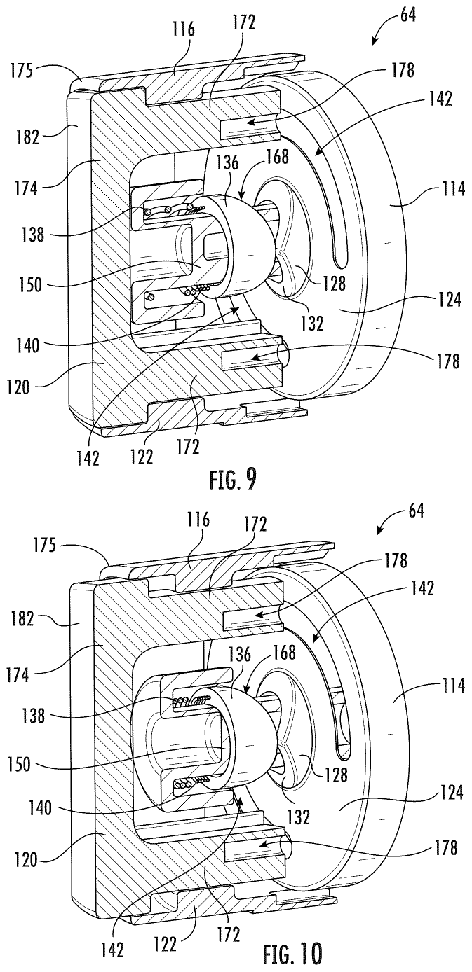

Turning now to FIGS. 2 through 10, various views are provided of a particular knob assembly 60 (e.g., including one control knob 64 being mountable to the cooking appliance 10) and portions thereof, such as might be provided at a particular knob assembly 60 in FIG. 1. In particular, FIG. 2 provides a cross-sectional view of the knob assembly 60. FIGS. 3 and 4 provide exploded views of the control knob 64. FIGS. 5 and 6 provide rear perspective views of the control knob 64 including a support plate 114 in a first discrete preload position and a second discrete preload position, respectively. FIGS. 7 and 8 provide sectional views of the control knob 64 in a static state and an adjustable state, respectively, wherein the support plate 114 is in the first discrete preload position. FIGS. 9 and 10 provide sectional views of the control knob 64 in a static state and an adjustable state, respectively, wherein the support plate 114 is in the second discrete preload position.

The knob assembly 60 may include a knob switch 100 and control knob 64, which are connected to each other and mounted on surface panel 76. In some embodiments, surface panel 76 defines one or more openings 102 that each define an axis to permit mechanical or electrical connections between portions of knob assembly 60 or controller 40 (e.g., within cabinet 12). For example, as shown in FIG. 2, the surface panel 76 may define the opening 102 having a central axis A extending from a rearward face 104 to a forward face 106 of surface panel 76 (e.g., perpendicular to the surface panel 76 or vertical direction V). Knob switch 100 may be disposed behind surface panel 76 (e.g., at the rearward face 104) while the control knob 64 is disposed in front of surface panel 76 (e.g., at the forward face 106).

The knob switch 100 may be provided as any suitable mechanism or device configured for detecting, or communicating a signal relating to, the rotational position of the control knob 64. For example, the knob switch 100 may include or be provided as a potentiometer, a digital encoder, or the like. In some exemplary embodiments, the knob switch 100 includes a suitable mechanical valve or electrical switch in communication with a slidable stem 108 and internal spring 110 of knob switch 100. The slidable stem 108 may be extended from a switch body 112 and through the surface panel 76 to form part of a suitable input mechanism for controlling a valve position or detecting and communicating a signal relating to the rotational position of control knob 64. The internal spring 110 may bias slidable stem 108 forward. During use, rotation of control knob 64 and the slidable stem 108 about the central axis A may alternately increase or decrease a voltage signal and, in turn, alternately increase or decrease an output of a heating element (e.g., heating element 44), as would be understood. Moreover, as would further be understood, internal spring 110 may be in forward-biased mechanical communication with the slidable stem 108 to require rearward translation of slidable stem 108 to permit subsequent rotation. Thus, after initially pushing slidable stem 108 rearward, slidable stem 108 may be permitted to rotate freely (e.g., within a predefined angle or circumferential path).

In some embodiments, control knob 64 includes various components that are generally mounted along and about a portion of central axis A (e.g., to direct the rotational position of slidable stem 108). Specifically, control knob 64 may include a support plate 114 that is rotatably mounted (e.g., indirectly) about the slidable stem 108 in front of the forward face 106. The control knob 64 may include an adjustable body 116 having or defining push surfaces 118 that may be rotationally fixed to the support plate 114 (e.g., while being slidable relative to the same). The control knob 64 may further include a static body 120 that may be disposed within a center projection 122 of the adjustable body 116.

The support plate 114 may be configured for adjusting a preload setting of the control knob 64. In particular, the support plate 114 may be selectively rotatable between a first discrete preload position (e.g., FIGS. 4, 6, and 7) and a second discrete preload position (e.g., FIGS. 5, 8, and 9) relative to the static body 120 or the adjustable body 116 to selectively adjust the control knob 64 between a first discrete preload setting and a second discrete preload setting. As will be appreciated in more detail below, the first discrete preload setting may correspond to a first push force required to depress or move the control knob 64 from the static state to the adjustable state and the second discrete preload setting may correspond to a second push force (e.g., that may be different from the first push force) required to depress or move the control knob 64 from the static state to the adjustable state.

The support plate 114 may include a front face 124 and a rear face 126, for instance, spaced apart along the central axis A. The support plate 114 may include a cam projection 128 extended from the front face 124 at a center of the support plate 114. The cam projection 128 and the support plate 114 may together define a center hole 130 that may be aligned coaxially with the central axis A, for instance, when the control knob 64 is mounted on the surface panel 76. The cam projection 128 may include a first cam surface 132 at a distal end of the cam projection 128. As will be appreciated in more detail below, the first cam surface 132 may be engaged with a complementary cam surface (e.g., a second cam surface 168 described in more detail below) to translate rotation of the support plate 114 to axial movement of a preload spacer 136, and in turn, a preload (e.g., compression) of a first spring 138 or a second spring 140.

The support plate 114 may define a plurality of tracks 142 through the support plate 114 for selective receipt of mechanical fasteners 144. The plurality of tracks 142 may be positioned radially outward of the center hole 130 for the receipt of mechanical fasteners 144. In some embodiments, the plurality of tracks 142 are arcuate (e.g., curved or arched) shaped tracks that may define two discrete preload positions. In particular, the plurality of tracks 142 may define the first discrete preload position (e.g., as shown in FIGS. 4, 6, and 7) and the second discrete preload position (e.g., as shown in FIGS. 5, 8, and 9) for the control knob 64. In some embodiments, the support plate 114 is rotated a predetermined angular displacement about the central axis A to move the support plate between the first discrete preload position and the second discrete preload position. For example, to move the support plate 114 from the first discrete preload position to the second discrete preload position, the support plate 114 may be rotated clockwise approximately ninety degrees (90°) relative to the static body 120. As another example, to move the support plate 114 from the second discrete preload position to the first discrete preload position, the support plate 114 may be rotated counterclockwise approximately ninety degrees (90°) relative to the static body 120.

After being rotated to the desired preload position (e.g., the first discrete preload position or the second discrete preload position), the support plate 114 may be held in place or otherwise secured to control knob 64 in the first discrete preload position or the second discrete preload position via the mechanical fasteners 144. In particular, the mechanical fasteners 144 may be extended through the plurality of tracks 142 and secured to the static body 120 to lock or hold the support plate 114 in the desired preload position. The mechanical fasteners 144 may include or be provided as any suitable fastener that may secure or fasten the support plate 114 to the control knob 64. For example, the mechanical fasteners 144 may include screws, bolts, or any other suitable fastener that may be secure the support plate 114 and may be selectively removed to adjust a preload position of the support plate 114.

The support plate 114 may be directly secured to the static body 120 via the mechanical fasteners 144 and may be indirectly (e.g., via the static body 120) secured to the adjustable body 116 via the mechanical fasteners 144. When assembled and secured in the desired preload position, the support plate 114 may be secured directly to the static body 120 and indirectly to the adjustable body 116 such that the support plate 114 may rotate with the adjustable body 116 and the static body 120 (e.g., when the adjustable body 116 is in the adjustable state) while remaining axially static relative to the surface panel 76.

In additional or alternative embodiments, one or more components of the control knob 64, such as the support plate 114, the adjustable body 116, or the static body 120 may include integrated fastening means, such as snaps, tabs, or the like that are configured for further securing or coupling the one or more components of the control knob 64.

The adjustable body 116 may generally be disposed in front of support plate 114. Specifically, the adjustable body 116 may be mounted to the slidable stem 108 to move therewith. Thus, the adjustable body 116 may be slidable (e.g., along the central axis A) relative to support plate 114. Moreover, the adjustable body 116 may be rotationally fixed to support plate 114 such that rotation of the adjustable body 116 and slidable stem 108 may also rotate support plate 114.

The adjustable body 116 may include a push body 146. The push body 146 may include the push surfaces 118 that extend outward, for instance, radially outward, from the slidable stem 108. In particular, push surfaces 118 may be radially spaced apart or outward from slidable stem 108 to permit a user to push the adjustable body 116. The adjustable body 116 may further include an outer skirt 148 extending from a perimeter of the adjustable body 116. For instance, the outer skirt 148 may extend to or toward the forward face 104 of the surface panel 76. In some embodiments, at least a portion of the outer skirt 148 is positioned around and concentric with the support plate 114.

A center cylinder 150 of adjustable body 116, which is disposed radially inward from the push body 146, may bridge the radial space between slidable stem 108 and push body 146 (e.g., behind the center projection 122). The center cylinder 150 may extend across the central axis A. In some embodiments, the center cylinder 150 forms a non-circular profile shape (e.g., a non-circular cross-section). In such embodiments, the center cylinder 150 includes an outer wall 152 that defines the non-circular profile shape. For instance, the outer wall 152 may include one or more indexed portions 154 (e.g., flat portions) that may extend along or may be parallel to the central axis A. Moreover, the center cylinder 150 may provide an attachment surface or structure to connect the adjustable body 116 to the slidable stem 108. For instance, the center cylinder 150 may define a slot 156 that is matched to the slidable stem 108. In other words, the shape of slot 156 may form the negative of the profile shape (e.g., a circular or non-circular profile shape) of the slidable stem 108 such that the slot 156 can receive the slidable stem 108 and be rotated by the same.

When assembled, the adjustable body 116 may be biased forward from or at a point apart from slidable stem 108. For instance, the adjustable body 116 may be in forward-biased mechanical communication with a first spring 138 or a second spring 140 of the control knob 64. The first spring 138 and the second spring 140 may each be disposed around the center cylinder 150 and positioned in a series arrangement. As shown, the first spring 138 may be directly engaged with the second spring 140 and positioned forward or in front of the second spring 140. Nonetheless, in additional or alternative embodiments, the first spring 138 and the second spring 140 may be positioned in any suitable series arrangement. For example, in additional or alternative embodiments, the second spring 140 may be positioned forward or in front of the first spring 138.

The first spring 138 may define a first spring rate and the second spring 140 may define a second spring rate. The first spring rate may be greater than the second spring rate. In some embodiments, the first spring rate is at least five times greater than the second spring rate. Notably, a first spring rate that is greater than the second spring rate, and more particularly, at least five times greater than a second spring rate, allows the first spring 138 to function or behave as a main spring and the second spring 140 to function as a tender or helper spring. As will be understood, when fully compressed the second spring 140 may provide a stable consistent platform for the first spring 138 to operate on. In other words, when fully compressed, the second spring 140 may function as a solid spacer for the first spring 138.

As shown, the first spring 138 and the second spring 140 may be formed or provided as coiled compression springs (e.g., to bias the adjustable body 116 forward relative to support plate 114). Nonetheless, in additional or alternative embodiments, the first spring 138 and the second spring 140 may be formed or provided as any suitable spring structure (e.g., leaf spring, sponge spring, torsion spring, etc.) that may be positioned between the support plate 114 and the adjustable body 116.

The control knob 64 may include a preload spacer 136 that may be movable, for instance, axially about the central axis A, relative to the adjustable body 116. The preload spacer 136 may be disposed around the center cylinder 150 and positioned between the second spring 140 and the support plate 114. The preload spacer 136 may include a ring body 158. The ring body 158 may include an outer wall 160 and an inner wall 162 positioned radially inward of the outer wall 160. The inner wall 162 may define an aperture 164 for receiving the center cylinder 150 therethrough. As mentioned above, the center cylinder 150 may define a non-circular profile shape. For example, the center cylinder 150 may include the outer wall 152 that includes the one or more indexed portions 154. In this regard, the outer wall 152 of the center cylinder 150 may define the non-circular profile shape. In some embodiments, the inner wall 162 of the ring body 158, and more particularly, a profile shape of the inner wall 162, is complementary to non-circular profile shape of the outer wall 152 of the center cylinder 150. For instance, the inner wall 162 may include one or more complementary indexed portions 167 that are matched to the one or more indexed portions 154 of the center cylinder 150. Notably, the inner wall 162 of the preload spacer 136 may be matched to the outer wall 152 of the center cylinder 150, such that the indexed portions 154 and the complementary indexed portion 167 prevent rotation of the preload spacer 136 relative to the center cylinder 150.

The ring body 158 may include a spring surface 166 and a second cam surface 168, for instance, spaced apart along the central axis A. The spring surface 166 may be positioned forward of the second cam surface 168 and may be engaged (e.g., directly engaged) with the rearward most spring in the series arrangement, for instance, the second spring 140. The second cam surface 168 may be engaged with the first cam surface 132 of the cam projection 128. In particular, the second cam surface 168 may be complementary to the first cam surface 132 such that rotational movement of the first cam surface 132 (e.g., caused by selectively rotating the support plate 114 between the first discrete preload position and the second discrete preload position) may result in axial movement of the preload spacer 136. As mentioned above, rotation of the preload spacer 136 (e.g., relative to the center cylinder 150) may be prevented due to the indexed portions 154 of the center cylinder 150 and the complementary indexed portions 167 of the preload spacer 136. In this regard, as the support plate 114 is rotated (e.g., between the first discrete preload position and the second discrete preload position), the preload spacer 136 may only move (e.g., forward or rearward) about the central axis A.

Separate from adjustable body 116, the static body 120 may be included with knob assembly 60. At least a portion of the static body 120 may be positioned in front of the center cylinder 150. Specifically, the static body 120 may be disposed within a body opening 170 defined by the center projection 122 of the adjustable body 116, for instance, inward of the push body 146. The static body 120 may include a plurality of mount feet 172 secured to the support plate 114 via the mechanical fasteners 144. The plurality of mount feet 172 may extend from a head portion 174 of the static body 120. The plurality of mount feet 172 may each be extended toward the surface panel 76. The plurality of mount feet 172 may each be extended through the body opening 170 and a plurality of feet apertures 176 defined through the push body 146 such that fastener holes 178 defined through a rear surface 180 of each foot of the plurality of mount feet 172 may align with the fastener holes 178 defined through the support plate 114. In this regard, mechanical fasteners 144 may be extended through the plurality of tracks 142 of the support plate 114 and the fastener holes 178 of the static body 120 to secure the static body 120 (e.g., directly) and the adjustable body 116 (e.g., indirectly via the static body 120) to the support plate 114. As should be appreciated, a number of tracks of the plurality of tracks 142 may correspond to a number of mount feet of the plurality of mount feet 172.

The static body 120 may be “static” in that it is configured as an axially static member that is not permitted to slide with slidable stem 108 relative to surface panel 76. Additionally or alternatively, the static body 120 may define a stop surface 182 that may be disposed flush with or forward from adjustable body 116 (e.g., the entirety of the adjustable body 116 depending on the state of the adjustable body 116). As shown in FIGS. 2, 6, 7, and 9, stop surface 182 may be positioned approximately flush to proud with the center projection 122 of the adjustable body 116 when the adjustable body 116 is in the static state. In particular, the stop surface 182 may be positioned in line with or slightly forward of the distal or forward most edge 175 of the center projection 122 of the adjustable body 116 when the adjustable body 116 is in the static state. As shown in FIGS. 8 and 10, stop surface 182 may be forward of the center projection 122 (e.g., a distal or forward most edge 175 of the center projection 122) of the adjustable body 116 when the adjustable body 116 is in the adjustable state. For instance, in the adjustable state, the adjustable body 116 may have traveled an adjustment distance, such as the distance between the outer skirt 148 and the forward face 104 of the surface panel 76.

As an illustrative example, during use, a user may activate or ignite a heating element, such as a particular heating element 44 from a rest state by pushing against the push surfaces 118 of a corresponding control knob 64 to move the adjustable body 116 from the static state toward the adjustable state. As the adjustable body 116 is pushed rearward, slidable stem 108 may also slide rearward into the switch body 112 of knob switch 100, thereby compressing internal spring 110 and at least one of the first spring 138 or the second spring 140. The static body 120 may remain axially static even as the adjustable body 116 moves rearward to the adjustable state. In the adjustable state, the adjustable body 116 and slidable stem 108 may be permitted to rotate to activate, ignite, or otherwise vary heat generated at the corresponding heating element. Once a user has completed adjustment of the heat (e.g., moved the control knob 64 to a desired setting or rotational position), the user may release the adjustable body 116, thereby allowing first spring 138 or the second spring 140 to motivate the adjustable body 116 forward (e.g., back towards the static state). In the desired setting or rotational position, the slidable stem 108 may not snap out of the locked position until the control knob 64 is returned to a rest state that corresponds to an OFF position of the particular heating element. Thus, other than in the OFF position, the slidable stem 108 may stay depressed to continue to allow rotation without pushing of the adjustable body 116.

As another illustrative example, when the support plate 114 is secured to the static body 120 in the first discrete preload position, the internal spring 110, the first spring 138 and the second spring 140 define a first discrete preload setting (e.g., as shown in FIGS. 4, 6, and 7). The first discrete preload setting may correspond to a first push force required to depress (e.g., move) the control knob 64 from the static state to the adjustable state. In the first discrete preload position, the first cam surface 132 of the cam projection 128 and the second cam surface 168 of the preload spacer 136 may be nested or fully interface. In this regard, the preload spacer 136 may be in its most rearward position (e.g., relative to the first spring 138 or the second spring 140) and may not preload either the first spring 138 or the second spring 140 in the static state of the control knob 64.

Due to the relative spring rates of the first spring 138 and the second spring 140 and the relative position of the preload spacer 136, when the support plate 114 is in the first discrete preload position, only the internal spring 110 and the second spring 140 may be compressed when a push force is applied to depress the adjustable body 116. For instance, the first spring rate of the first spring may be greater than an internal spring rate of the internal spring 110 and also of the second spring rate of the second spring 140. In this regard, in the first preload position, the second spring 140 and the internal spring 110 may be compressed prior to compression of the first spring 138, for instance, when a push force is applied to the adjustable body 116. Notably, the second spring 140 defines a working travel distance that is approximately equivalent to the adjustment distance of the adjustable body 116 (e.g., a distance required to move the adjustable body 116 from the static state to the adjustable state). In this regard, when the push force is applied to the adjustable body 116, the internal spring 110 and the second spring 140 may be compressed to translate the slidable stem 108 rearward.

Notably, the second spring 140 may fully compress when the adjustable body 116 reaches it maximum adjustment distance and the first spring 138 may remain uncompressed. Thus, in the adjustable state of the control knob 64, the first spring 138 may function or behave as a solid spacer engaged with a forward end of the second spring 140. In this regard, the first discrete preload setting may be based on the internal spring rate of the internal spring 110 and the second spring rate of second spring 140.

As yet another illustrative example, when the support plate 114 is secured to the static body 120 in the second discrete preload position, the internal spring 110, the first spring 138, and the second spring 140 define a second discrete preload setting (e.g., as shown in FIGS. 5, 8, and 9). In the second discrete preload position, the preload spacer 136 is moved forward (e.g., along the central axis A) due to engagement between the first cam surface 132 and the second cam surface 168. In this regard, the preload spacer 136 may be in its most forward position (e.g., relative to the cam projection 128) and may preload (e.g., compress) the second spring 140 in the static state of the control knob 64. In particular, in such a position, the preload spacer 136 may fully compress the second spring 140 in the static state of the control knob 64. In this regard, the second spring 140 may function or behave as a solid spacer between the preload spacer 136 and the first spring 138. As the second spring 140 is fully preloaded (e.g., fully compressed), only the internal spring 110 and the first spring 138 may be compressed when a push force is applied to the adjustable body 116. Thus, the second discrete preload setting may be based on the internal spring rate of the internal spring 110 and the first spring rate of first spring 138.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cooktop;
a heating element mounted to the cooktop;
a surface panel mounted to the cooktop forward from the heating element, the surface panel comprising a forward face and a rearward face, the surface panel defining a central axis extending from the rearward face to the forward face; and
a control knob mounted to the cooking appliance at the surface panel, the control knob comprising:
an adjustable body comprising a push body, a center projection defining a body opening, and a center cylinder positioned radially inward of the push body;
a static body disposed within the body opening of the center projection, at least a portion of the static body being positioned in front of the center cylinder;
a first spring disposed around the center cylinder;
a second spring disposed around the center cylinder, the second spring and the first spring being in a series arrangement; and
a support plate selectively rotatable between a first discrete preload position and a second discrete preload position relative to the static body to selectively adjust the control knob between a first discrete preload setting and a second discrete preload setting.

2. The cooking appliance of claim 1, wherein the control knob further comprises
a preload spacer disposed around the center cylinder and positioned between the second spring and the support plate.

3. The cooking appliance of claim 2, wherein the support plate further comprises a cam projection,
wherein the cam projection comprises a first cam surface at a distal end of the cam projection,
wherein the preload spacer comprises a spring surface and a second cam surface,
wherein the spring surface is engaged with the second spring, and
wherein the second cam surface is engaged with the first cam surface.

4. The cooking appliance of claim 2, wherein the center cylinder comprises an outer wall defining a non-circular profile shape,
wherein the preload spacer includes an inner wall defining an aperture for receipt of the center cylinder, and
wherein the inner wall is complementary to the non-circular profile shape defined by the outer wall.

5. The cooking appliance of claim 1, wherein the first spring defines a first spring rate,
wherein the second spring defines a second spring rate, and
wherein the first spring rate is greater than the second spring rate.

6. The cooking appliance of claim 5, wherein the first spring rate is at least five times greater than the second spring rate.

7. The cooking appliance of claim 1, further comprising:
a knob switch being disposed behind the surface panel, the knob switch comprising an internal spring and a slidable stem extending through the central axis, the slidable stem being in forward-biased mechanical communication with the internal spring.

8. The cooking appliance of claim 7, wherein the adjustable body is mounted to the slidable stem at the center projection,
wherein the center cylinder defines a slot matched to the slidable stem to be rotated thereby, and
wherein the slidable stem is received within the slot.

9. The cooking appliance of claim 1, wherein the static body comprises a head portion and a plurality of mount feet,
wherein the plurality of mount feet each extend from the head portion toward the surface panel, and
wherein the plurality of mount feet are positioned within feet apertures defined through the push body.

10. The cooking appliance of claim 9, wherein the support plate defines a plurality of tracks for selective receipt of mechanical fasteners, and
wherein the plurality of mount feet are secured to the support plate via the mechanical fasteners.

11. A knob assembly for a cooking appliance, the cooking appliance comprising a cooktop, a heating element mounted to the cooktop, and a surface panel mounted to the cooktop forward from the heating element, the surface panel comprising a forward face and a rearward face, the surface panel defining a central axis extending from the rearward face to the forward face, the knob assembly comprising:
a control knob mountable to the cooking appliance, the control knob comprising:
an adjustable body comprising a push body, a center projection defining a body opening, and a center cylinder positioned radially inward of the push body;
a static body disposed within the body opening of the center projection, at least a portion of the static body being positioned in front of the center cylinder;
a first spring disposed around the center cylinder;
a second spring disposed around the center cylinder, the second spring and the first spring being in a series arrangement; and
a support plate selectively rotatable between a first discrete preload position and a second discrete preload position relative to the static body to selectively adjust the control knob between a first discrete preload setting and a second discrete preload setting.

12. The knob assembly of claim 11, further comprising:
a preload spacer disposed around the center cylinder and positioned between the second spring and the support plate.

13. The knob assembly of claim 12, wherein the support plate further comprises a cam projection,
wherein the cam projection comprises a first cam surface at a distal end of the cam projection,
wherein the preload spacer comprises a spring surface and a second cam surface,
wherein the spring surface is engaged with the second spring, and
wherein the second cam surface is engaged with the first cam surface.

14. The knob assembly of claim 12, wherein the center cylinder comprises an outer wall defining a non-circular profile shape,
wherein the preload spacer includes an inner wall defining an aperture for receipt of the center cylinder, and
wherein the inner wall is complementary to the non-circular profile shape defined by the outer wall.

15. The knob assembly of claim 11, wherein the first spring defines a first spring rate,
wherein the second spring defines a second spring rate, and
wherein the first spring rate is greater than the second spring rate.

16. The knob assembly of claim 15, wherein the first spring rate is at least five times greater than the second spring rate.

17. The knob assembly of claim 11, further comprising:
a knob switch being disposed behind the surface panel, the knob switch comprising an internal spring and a slidable stem extending through the central axis, the slidable stem being in forward-biased mechanical communication with the internal spring.

18. The knob assembly of claim 17, wherein the adjustable body is mounted to the slidable stem at the center projection,
wherein the center cylinder defines a slot matched to the slidable stem to be rotated thereby, and
wherein the slidable stem is received within the slot.

19. The knob assembly of claim 11, wherein the static body comprises a head portion and a plurality of mount feet,
wherein the plurality of mount feet each extend from the head portion toward the surface panel, and
wherein the plurality of mount feet are positioned within feet apertures defined through the push body.

20. The knob assembly of claim 19, wherein the support plate defines a plurality of tracks for selective receipt of mechanical fasteners, and
wherein the plurality of mount feet are secured to the support plate via the mechanical fasteners.
